(19) United States
(12) Patent Application Publication
(10) Pub. No.: US 2003/0154828 A1
(43) Pub. Date: Aug. 21, 2003

(54) Rotating head AN fitting open end wrench

(76) Inventor: Jeffrey D. Weaver, Mooresville, NC (US)

Correspondence Address: JEFFREY D. WEAVER, 215 RACEWAY DRIVE, MOORESVILLE, NC, 28117, US

(21) Appl. No.: 10/079,777

(22) Filed: Feb. 19, 2002

(51) Int. Cl. B25B 13/00

(52) U.S. Cl. 81/124.4

(57) ABSTRACT

A open end wrench tool with a rotating wrench head having multiple openings of different sizes and a method of locking and releasing with a setting motion the rotating wrench head. A wrench tool that can be quickly changed to different sized wrench openings sized to fit hydraulic, oil, and water and fuel line fittings, generally known as AN (Air Force-Navy) fittings.

### BACKGROUND OF THE INVENTION

1. Field of Invention

This invention relates to a tool for changing hydraulic, oil, water, air/gas and fuel line fittings, more particularly a multiple opening rotating wrench head that provides a quick change capability to change the wrench size.

2. Description of Background Information

Frequently, it is desired to install and remove tube and hose fittings without having the inconvenience of having to replace the wrench size and wrench angle, particularly while working in confined spacing such as aircraft systems or motor sport engine installations.

AN (Air Force-Navy) fittings relate to military design standards that have been adapted to general use for motor sports applications and in the aircraft and boating industries. AN wrenches used to remove and replace AN fittings are generally short handled open-end wrenches that are one size for each wrench handle. Work is generally performed in a confined space and the need to change wrench sizes is an inconvenience, requiring time for personnel to remove themselves from the work area to obtain needed wrench size changes. The present invention responds to the need for a simple functioning wrench system providing multiple wrench size choices available to personnel working in confined environments. Review of prior art has not disclosed fitting tools in use having the quick size change and selection features of this invention.

### SUMMARY OF INVENTION

The Primary objective and advantage of this the invention is to provide a unique multiple open end wrench meeting user needs for quickly changing wrench sizes without having to replace the wrench while working in difficult or confined spaces. Particular to this invention is a rotating open-end wrench head consisting of at least three sizes to fit AN fittings and a convenient locking feature.

Another objective and advantage of this invention is having a rotating wrench head attached to an ergonomically designed handle, fitting comfortably in the palm of the hand and clearing obstacles where limited access is available.

Another objective and advantage of this invention is to provide a wrench head having openings at an angle to facilitate access in confined spaces where an angled facing wrench opening is required.

Another objective and advantage of this invention is having a quick and secure means for locking the rotating wrench head and conveniently and quickly releasing the locking feature. Then rotating the wrench head to a desired position, releasing the locking apparatus into the lock position by having a spring force.

Another objective and advantage of this invention is having a reduction in the number of wrenches required to be carried for a task. Particularly, having at least three wrench sizes available for a wrench and having capability for setting to angled positions. A further objective and advantage of this invention is having generally two or three wrench tools being capable of meeting most task size requirements.

Another objective and advantage of this invention is having additional wrench opening size capabilities (other than AN-fittings) to meet other applications such as fitting standard bolt head sizes.

Other objectives and advantages of the present invention will become apparent from the following descriptions, taken in connection with the accompanying drawings, wherein, by way of illustrated and example, an embodiment of the present invention is disclosed.

### BRIEF DESCRIPTION OF THE DRAWINGS

The drawings constitute a part of this specification and include the embodiment of this invention.

FIG. 1 is a plan view of the rotating wrench assembly of the present invention.

FIG. 2 is a top view of the rotating wrench assembly of the present invention.

FIG. 3 is a section view of the present invention taken along line 3-3 of FIG. 2.

FIG. 4 is partial view of the present invention locking and release pin assembly.

### DETAILED DESCRIPTION OF THE INVENTION

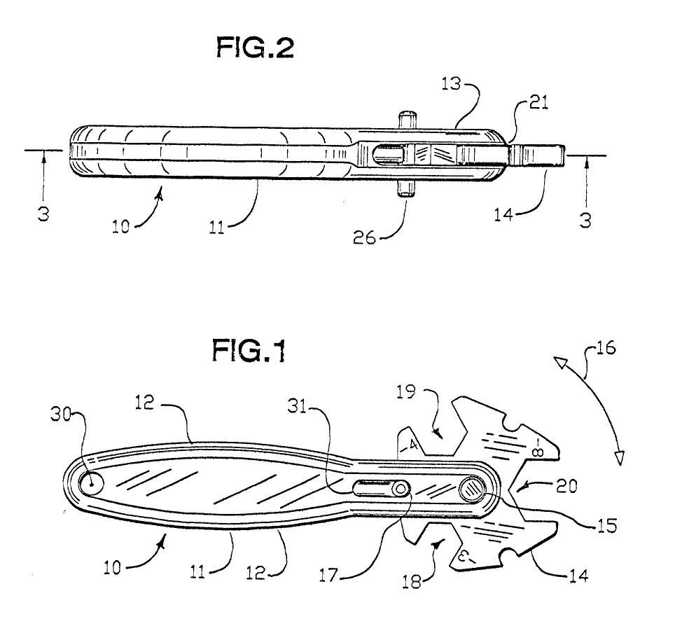

Referring to FIGS. 1 and 2, wrench assembly 10 is illustrated comprising an elongate handle 11 being ergonomically formed to comfortably fit the palm of the hand thereby having substantially arcuate sides 12, at the opposite end there being longitudinal extension 13 having a rotating open-end wrench head 14 secured by pivot pin 15 therein secured by press fit into extension 13, thereby permitting wrench head 14 to rotate 16 in a preferred manor into a desired lock position 17. Continuing with FIG. 1, wrench head 14 therein having at least three wrench opening sizes for AN fittings. The AN fitting sizes (−3, −4, −8) in this example being etched on wrench head 14, as illustrated next to the wrench openings 18, 19 and 20. Referring to FIG. 2, wrench head 14 is located in wrench head slot 21 centered within the longitudinal extension 13.

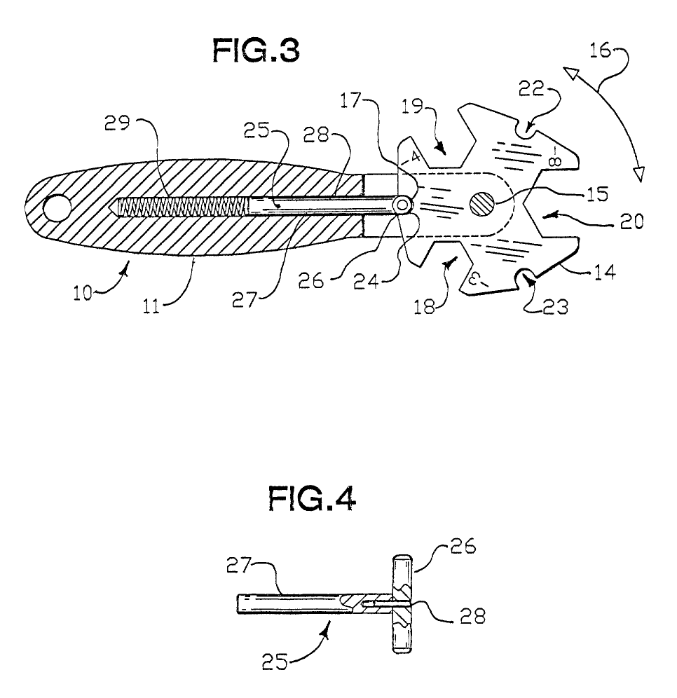

As best shown in FIG. 3 a section view taken along line 3-3 of FIG. 2, the embodiment of the locking and release apparatus is disclosed. Wrench head 14 cooperating rotationally 16 with pivot pin 15, wrench head 14 having located opposite to each wrench opening 18, 19, and 20 there being locking ports 22, 23 and 24. Locking apparatus 25 is shown in lock position 17, having locking and release pin 26 engaged into locking port 24 of wrench head 14. The locking and release apparatus 25, shaft member 27 cooperates within cavity 28 centered within handle 11, locking apparatus 25 is actuated by compression spring 29 having a force reaction onto locking pin 26 there being retained by side slots 31 noted in FIG. 1, into locking port 24 of wrench head 14. To release or unlock the wrench head 14 and rotate to a desired position, the compression spring 29 is compressed by retracting and disengaging the lock pin 26 and locking apparatus 25 from locking port 24 position illustrated. Retracting the lock pin 26 against the spring 29 while rotating wrench head 14 to the general area of the desired wrench size position and releasing, spring compression force conveniently snaps the wrench head 14 and locking apparatus 25 into position for the selected locking port 22, 23 or 24, the lock pin 26 being locked into the selected wrench head locking port.

Referring to FIG. 4, the port locking and release apparatus 25 is disclosed, consisting a shaft 27 and lock pin 26 being cylindrical having a diameter of approximately 6.35 mm in the example for the present invention. The assembly is completed by spring pin 28 being installed on center of shaft 27 and matching center hole in perpendicular lock pin 26. This embodiment being assembled within handle extension 13, thereby having a safe and secure locking apparatus contained within handle 11.

Returning to FIG. 1, noting handle 11 therein being machined from a high quality wrought aluminum billet for strength and lightness. Noting wrench head 14 therein being a quality steel, in this embodiment being SAE 1018 steel and having a thickness of approximately 7.62 mm in the example for the present invention. The noted materials are preferred and material selection is not limited to the noted examples. Handle 11 therein having a hole 30 for the purpose of hanging the wrench assembly in a tool access location. Continuing with FIG. 1, note that wrench openings 18, 19 and 20 each being capable of connecting to 3 different fitting sizes while in the illustrated wrench head position. Thus having the ability to reach fittings requiring angled wrench access.

What is claimed is:

1. An open-end wrench tool having a handle and therein being attached a rotating wrench head having multiple open-end wrench size selections, said rotating wrench head member locking into a desired position therein having locking and release apparatus activated by compression spring comprising;
a handle ergonomically formed to fit the palm of a operators hand thereby having substantially arcuate form, extending from said handle being an elongated longitudinal extension therein a slot opening centered on the extension end to engage a rotating wrench head, said handle having a cylindrical passage extending from said slot opening into the center of arcuate handle, having purpose to retain therein a compression spring and a locking and release apparatus, said handle extension having slots extending from side to side therein retaining the locking and release apparatus pin for purpose thereto engage and thereby locking rotating wrench head, said side slots having length to define retraction travel distance, said handle having a hole feature at end opposite wrench head for purpose of hanging the tool for storage;
a rotating wrench head having a series of equally spaced wrench openings, generally 3 in number, each being a size selected to fit AN (Air Force-Navy) fittings commonly used in tubing and hose fittings, said wrench head rotating thereby having centrally located pivot pin at the end of the elongated handle extension for purpose of rotating wrench head cooperating with a slot centered within the handle extension thereto retain the rotating wrench head and function, said wrench head having locking ports positioned opposite wrench head openings for purpose of positioning and locking the wrench head into selected positions, said locking ports being circular sized to cooperate with locking engagement thereto a circular locking pin actuating within the handle and extension;
a wrench head locking apparatus contained within the handle for purpose of engaging locking ports and locking the rotating wrench head into selected position, comprising a compression spring thereto exert force for locking apparatus to engage and lock the wrench head into use positions, said compression spring and locking apparatus shaft member therein being centrally located within handle circular passage, said locking apparatus being constructed having a shaft thereto cooperate with handle passage and compression spring, said shaft being assembled having locking pin member perpendicular to the shaft there being secured by a spring pin centered within the shaft longitudinal axis and centered through the center of the perpendicular locking pin, assembly being accomplished and retained within the handle.

2. The wrench of claim 1, wherein wrench head having lighting holes being placed within solid section locations between wrench openings and opposite wrench head locking ports.

3. The wrench of claim 1, wherein wrench head openings being sized to fit bolt hardware or fittings other than AN type fittings.

4. The wrench of claim 1, wherein individual wrenches being made available in sets having complementary size progression, generally being sets of two or three wrench tools having AN fitting size progression of three sizes for each wrench tool, By way of example, wrench #1 having sizes −3, −4, −6, wrench #2 having sizes −6, −8, −10 and wrench #3 having sizes −12, −16, −20.

5. The wrench of claim 1, wherein the handle length being longer for applications requiring increased turning force or torque.
